(19) United States
(12) Patent Application Publication
(10) Pub. No.: US 2022/0198149 A1
(43) Pub. Date: Jun. 23, 2022

(54) METHOD AND SYSTEM FOR MACHINE READING COMPREHENSION

(71) Applicant: INDUSTRIAL TECHNOLOGY RESEARCH INSTITUTE, Hsinchu (TW)

(72) Inventor: Xuan-Wei WU, Taichung City (TW)

(73) Assignee: INDUSTRIAL TECHNOLOGY RESEARCH INSTITUTE, Hsinchu (TW)

(21) Appl. No.: 17/132,420

(22) Filed: Dec. 23, 2020

(51) Int. Cl. G06F 40/30; G06F 40/126; G06F 40/186; G06F 40/284; G06F 16/332; G06F 16/33

(52) U.S. Cl. CPC G06F 40/30; G06F 40/126; G06F 16/3346; G06F 40/284; G06F 16/3329; G06F 40/186

(57) ABSTRACT

A method for machine reading comprehension comprises obtaining question text and article text associated with the question text, generating first knowledge text corresponding to the question text and second knowledge text corresponding to the article text according to a knowledge set, encoding the question text and the article text to generate an original target text code, encoding the first knowledge text and the second knowledge text to generate a knowledge text code, performing a fusion operation on the original target text code and the knowledge text code to introduce part of knowledge in the knowledge set into the original target text code to generate a strengthened target text code, obtaining an answer corresponding to the question text based on the strengthened target text code, and outputting the answer.

### TECHNICAL FIELD

This disclosure relates to a method of natural language processing.

### BACKGROUND

Machine reading comprehension (MRC) is a technology that allows computers to read articles and answer related questions. In recent years, a large number of textual materials in various industries have been produced. Therefore, traditional manual processing methods, such as listing FAQ, face problems such as slow processing speed, great expense, and incomplete coverage of question and answer pairs. The processing of said large number of textual materials may even become a bottleneck for business development. Accordingly, the demand for machine reading comprehension is gradually increasing.

However, in general, for the sake of brevity and literary beauty, authors often omit people's common sense when writing articles. In addition, when writing professional articles (such as medical papers), authors often assume that readers have relevant background knowledge and do not write too much background knowledge in the article. Therefore, if such articles are used as training data or target data for finding answers, the accuracy of the answers obtained by the system for machine reading comprehension will be quite low.

### SUMMARY

In view of the above, a method and system for machine reading comprehension are provided in this disclosure.

According to an embodiment of this disclosure, a method for machine reading comprehension comprises obtaining question text and article text associated with the question text, generating first knowledge text corresponding to the question text and second knowledge text corresponding to the article text according to a knowledge set, encoding the question text and the article text to generate an original target text code, encoding the first knowledge text and the second knowledge text to generate a knowledge text code, performing a fusion operation on the original target text code and the knowledge text code to introduce part of knowledge in the knowledge set into the original target text code to generate a strengthened target text code, obtaining an answer corresponding to the question text based on the strengthened target text code, and outputting the answer.

According to an embodiment of this disclosure, a system for machine reading comprehension comprises an input-output interface, a knowledge text generator, a semantic encoder, a code fusion device and an answer extractor, wherein the knowledge text generator is connected to the input-output interface, the semantic encoder is connected to the input-output interface and the knowledge text generator, the code fusion device is connected to the semantic encoder, and the answer extractor is connected to the code fusion device. The input-output interface is configured to obtain question text and article text associated with the question text. The knowledge text generator is configured to obtain first knowledge text corresponding to the question text and second knowledge text corresponding to the article text according to a knowledge set. The semantic encoder is configured to encode the question text and the article text to generate an original target text cod and to encode the first knowledge text and the second knowledge text to generate a knowledge text code. The code fusion device is configured to perform a fusion operation on the original target text code and the knowledge text code to introduce part of knowledge in the knowledge set into the original target text code to generate a strengthened target text code. The answer extractor is configured to obtain an answer corresponding to the question text based on the strengthened target text code and to output the answer through the input-output interface.

With the above architecture, the method and system for machine reading comprehension in this disclosure may perform specific encoding and fusion operations to introduce external knowledge in the process of analyzing problems and articles, thereby avoiding the problem that it is difficult to obtain a correct answer from an article due to the simple content of the article, and improving the accuracy of answer prediction.

The above description of the summary of this disclosure and the description of the following embodiments are provided to illustrate and explain the spirit and principles of this disclosure, and to provide further explanation of the scope of this disclosure.

### BRIEF DESCRIPTION OF THE DRAWINGS

FIG. 1 is a function block diagram of a system for machine reading comprehension and an external knowledge database according to an embodiment of this disclosure.

FIG. 2 is a flow chart of a method for machine reading comprehension according to an embodiment of this disclosure.

FIG. 3 is a flow chart of generation of knowledge text in a method for machine reading comprehension according to an embodiment of this disclosure.

FIGS. 4A-4C are schematic diagrams of an encoding task in a method for machine reading comprehension according to an embodiment of this disclosure.

FIGS. 5A-5C are schematic diagrams of a fusion operation in a method for machine reading comprehension according to an embodiment of this disclosure.

FIGS. 6A and 6B are flow charts of an answer extraction task in a method for machine reading comprehension according to two embodiments of this disclosure respectively.

FIG. 7 is a flow chart of optimization of operating parameters in a method for machine reading comprehension according to an embodiment of this disclosure.

FIG. 8A is a comparison chart of experimental data obtained using the first kind of training data by an existing system for machine reading comprehension and experimental data obtained using the first kind of training data by a system for machine reading comprehension in an embodiment of this disclosure.

FIG. 8B is a comparison chart of experimental data obtained using the second kind of training data by an existing system for machine reading comprehension and experimental data obtained using the second kind of training data by a system for machine reading comprehension in an embodiment of this disclosure.

### DETAILED DESCRIPTION

The detailed features and advantages of this disclosure will be described in detail in the following description, which is intended to enable any person having ordinary skill in the art to understand the technical aspects of this disclosure and to practice it. In accordance with the teachings, claims and the drawings of this disclosure, any person having ordinary skill in the art is able to readily understand the objectives and advantages of this disclosure. The following embodiments illustrate this disclosure in further detail, but the scope of this disclosure is not limited by any point of view.

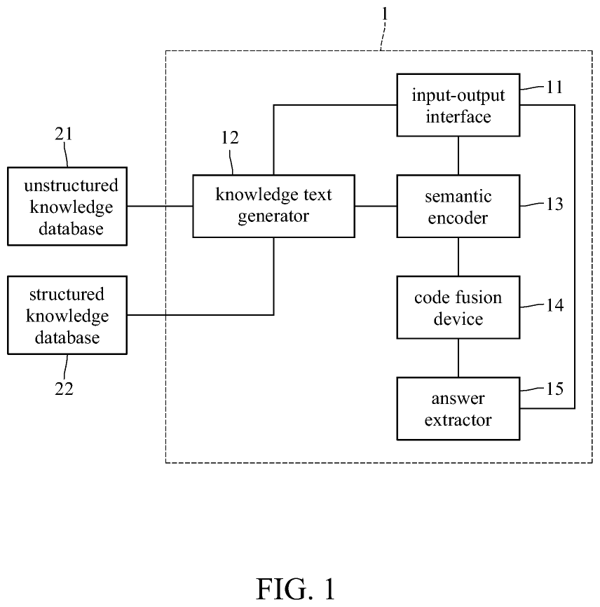

Please refer to FIG. 1, which is a function block diagram of a system for machine reading comprehension and an external knowledge database according to an embodiment of this disclosure. As shown in FIG. 1, a system for machine reading comprehension (machine reading comprehension system 1) includes an input-output interface 11, a knowledge text generator 12, a semantic encoder 13, a code fusion device 14 and an answer extractor 15, wherein the knowledge text generator 12 is connected to the input-output interface 11 and may be connected to an unstructured knowledge database 21 and/or a structured knowledge database 22 outside the system, the semantic encoder 13 is connected to the input-output interface 11 and the knowledge text generator 12, the code fusion device 14 is connected to the semantic encoder 13, and the answer extractor 15 is connected to the code fusion device 14 and the input-output interface 11.

The input-output interface 11 is configured to obtain question text and article text associated with the question text, and may be configured to output the answer that corresponds to the question text and is determined by another device of the system. The question text and the article text may be text files. The question text indicates the question for which the answer is sought, and the article text indicates the possible source of the answer. In an example, in the application of intelligent customer service, a product description or rules for an event may be used as the article text, and inquiries about product usage or discounts in the event may be used as the question text. In another example, in the application of smart medicine (eHealth), medical records or medical papers may be used as the article text, and inquiries about the cause or treatment may be used as the question text. The above examples are merely illustrative and not intended to limit this disclosure.

The input-output interface 11 may include an input device such as a keyboard, a mouse or a touch screen for a user to input or select question text or article text, and may also include an output device such as a display to output the answer generated by the answer extractor 15. Or, the input-output interface 11 may be a wired or wireless port for connecting to devices outside the system (e.g. mobile phone, tablet, personal computer, etc.) to receive the question text and the article text or receive instructions for selecting the specific question text and article text, and may transmit the answer generated by the answer extractor 15 to the devices outside the system. Or, besides the input and output devices or the port as above-mentioned, the input-output interface 11 may further include a processing module. The input-output interface 11 may receive the question text or an instruction for selecting the specific question text by the input device or the port, and then search the internal database of the system or an external database outside the system for the article text associated with the question text. More particularly, the processing module may determine the type of the question text or the event to which the question text belongs according to keywords in the question text or tags attached to the question text, and search for the article text with the same type or belonging to the same event.

The knowledge text generator 12, the semantic encoder 13, the code fusion device 14, the answer extractor 15 and the processing module that the input-output interface 11 may have as aforementioned may be implemented by the same processor or multiple processors, wherein the so-called processor is, for example, central processing unit (CPU), microcontroller, programmable logic controller (PLC), etc.

The knowledge text generator 12 is configured to receive the question text and the article text from the input-output interface 11, and to generate first knowledge text corresponding to the question text and second knowledge text corresponding to the article text according to a knowledge set. The knowledge set may be provided by one or both of the unstructured knowledge database 21 and the structured knowledge database 22. The unstructured knowledge database 21 and the structured knowledge database 22 may be public databases on the Internet or internal databases of a company. The unstructured knowledge database 21 stores a number of pieces of unstructured knowledge, wherein the pieces of unstructured knowledge may be textual descriptions of specific words respectively. For example, unstructured knowledge database 21 may include Wikipedia, dictionaries, etc. The structured knowledge database 22 stores a number of pieces of structured knowledge, wherein the pieces of structured knowledge may be relations between specific words and other words, for example, expressed in the form of triples of “entity-relation-entity”, and the triples may form a knowledge graph. Moreover, the knowledge text generator 12 may output at least part of the knowledge set through the input-output interface 11. More particularly, the knowledge text generator 12 may output knowledge data stored in the unstructured knowledge database 21 and/or the structured knowledge database 22 through the input-output interface 11, and/or output the knowledge text generated by the knowledge text generator 12 through the input-output interface 11 for a user to view or adjust it. The further implementation of generating the knowledge text according to the above-mentioned knowledge set performed by the knowledge text generator 12 is described later.

The semantic encoder 13 is configured to receive the question text and the article text from the input-output interface 11, to encode the question text and the article text to generate an original target text code, to receive the first knowledge text and the second knowledge text generated by the knowledge text generator 12 from the knowledge text generator, and to encode the first knowledge text and the second knowledge text to generate a knowledge text code. The semantic encoder 13 may perform encoding tasks in various ways including non-contextualized encoding and contextualized encoding, and the further implementations are described later.

The code fusion device 14 is configured to perform a fusion operation on the original target text code and the knowledge text code generated by the semantic encoder 13 to introduce part of knowledge in the knowledge set into the original target text code to generate a strengthened target text code. The answer extractor 15 is configured to obtain an answer corresponding to the question text based on the strengthened target text code, and to output the answer through the input-output interface 11 including an output device such as a display or a wired/wireless port for connecting to devices outside the system (e.g. mobile phone, tablet, personal computer, etc.) and transmitting the answer to the devices outside the system. The further implementations of the fusion operation performed by the code fusion device 14 and the answer extraction task performed by the answer extractor 15 are described later.

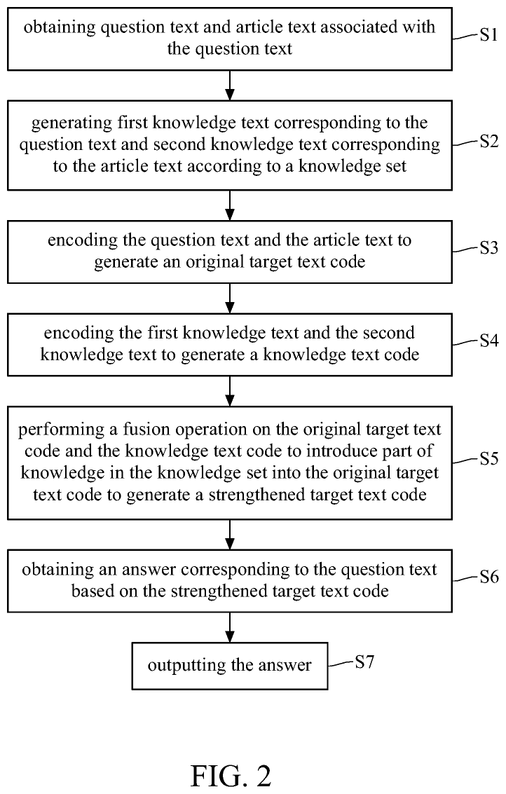

Please refer to FIG. 1 and FIG. 2, wherein FIG. 2 is a flow chart of a method for machine reading comprehension according to an embodiment of this disclosure. The method for machine reading comprehension as shown in FIG. 2 is applicable for the machine reading comprehension system 1 as shown in FIG. 1, but is not limited to this. As shown in FIG. 2, a method for machine reading comprehension includes step S1: obtaining question text and article text associated with the question text; step S2: generating first knowledge text corresponding to the question text and second knowledge text corresponding to the article text according to a knowledge set; step S3: encoding the question text and the article text to generate an original target text code; step S4: encoding the first knowledge text and the second knowledge text to generate a knowledge text code; step S5: performing a fusion operation on the original target text code and the knowledge text code to introduce part of knowledge in the knowledge set into the original target text code to generate a strengthened target text code; step S6: obtaining an answer corresponding to the question text based on the strengthened target text code; step S7: outputting the answer. In the following, various implementations of the method for machine reading comprehension as shown in FIG. 2 are exemplarily described using the machine reading comprehension system 1 as shown in FIG. 1.

In step S 1, the input-output interface 11 can obtain question text and article text associated with the question text. More particularly, the input-output interface 11 may directly receive the files of the question text and article text, receive instructions for selecting the specific question text and article text, or receive the question text/an instruction for selecting the specific question text and then search the internal database of the system or an external database outside the system for the article text associated with the question text. The way to search for the article text associated with the question text may be: determining the type of the question text or the event to which the question text belongs according to keywords in the question text or tags attached to the question text, and then searching for the article text with the same type or belonging to the same event. For example, the input-output interface 11 searches for the medical article text when determining that the question text is medical; the input-output interface 11 searches for the article relevant to an anniversary event as the article text when determining that the question text indicates the question relevant to the anniversary event. The above examples are merely illustrative and not intended to limit this disclosure.

In step S2, the knowledge text generator 12 can generate first knowledge text corresponding to the question text and second knowledge text corresponding to the article text according to the knowledge set. In other words, the knowledge text generator 12 may take each of the question text and the article text as text to be processed so as to generate the corresponding knowledge text. The knowledge set includes knowledge stored in one or both of the unstructured knowledge database 21 and the structured knowledge database 22. In other words, the knowledge text generator 12 may search the unstructured knowledge database 21 and/or the structured knowledge database 22 for materials used to generate the first knowledge text and the second knowledge text.

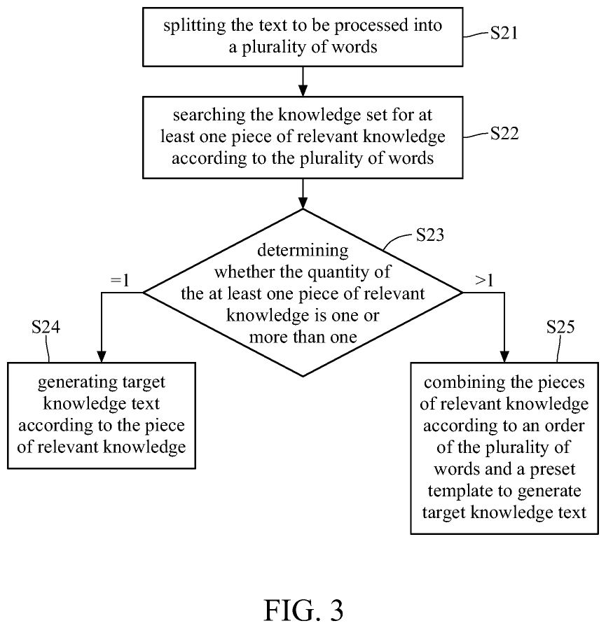

For a further description of the procedure for generating knowledge text, please refer to FIG. 1 and FIG. 3, wherein FIG. 3 is a flow chart of generation of knowledge text in a method for machine reading comprehension according to an embodiment of this disclosure. As shown in FIG. 3, a procedure for generating knowledge text may include step S21: splitting the text to be processed into a plurality of words; step S22: searching the knowledge set for at least one piece of relevant knowledge according to the plurality of words; step S23: determining whether the quantity of the at least one piece of relevant knowledge is one or more than one; when the quantity of the at least one piece of relevant knowledge is one, performing step S24: generating target knowledge text according to the piece of relevant knowledge; and when the quantity of the at least one piece of relevant knowledge is more than one, performing step S25: combining the pieces of relevant knowledge according to an order of the plurality of words and a preset template to generate target knowledge text; wherein the target knowledge text generated by taking the question text as the text to be processed is the first knowledge text, and the target knowledge text generated by taking the article text as the text to be processed is the second knowledge text.

In step S21, the knowledge text generator 12 may split the text to be processed into a number of words by a natural language analysis technique. In step S22, the knowledge text generator 12 may take each of the words as a keyword to search the knowledge set for the knowledge relevant to the keyword, that is, search the unstructured knowledge database 21 and/or the structured knowledge database 22 for the knowledge relevant to the keyword. In particular, the quantity of the keywords included in the text to be processed may not correspond to the quantity of the searched pieces of relevant knowledge. A keyword may correspond to zero, one or more pieces of relevant knowledge. In other words, the quantity of pieces of relevant knowledge obtained by the knowledge text generator 12 may be zero, one or more. When the quantity of pieces of relevant knowledge is zero, the knowledge text generator 12 stops working and/or outputs an error signal; when the quantity of pieces of relevant knowledge is one or more than one, the knowledge text generator 12 works as follows.

In steps S23-S25, when the quantity of pieces of relevant knowledge is one, the knowledge text generator 12 generates target knowledge text according to this piece of relevant knowledge; when the quantity of pieces of relevant knowledge is more than one, the knowledge text generator 12 combines the pieces of relevant knowledge according to the order of the words generated by splitting and a preset template (first preset template) to generate the target knowledge text. For example, the first preset template indicates concatenating the textual descriptions of all of the pieces of relevant knowledge, and separating every two pieces of relevant knowledge with a separator (e.g. a period), wherein the order of the concatenation is the same as the order of the words, but not limited to this. In another embodiment, the knowledge text generator 12 may process the concatenated textual descriptions by a system for text summarization to generate a concise version of the knowledge text as the target knowledge text. Moreover, when the quantity of the pieces of relevant knowledge obtained by the knowledge text generator 12 is greater than a preset processing limit, the knowledge text generator 12 may filter the pieces of relevant knowledge according to the type of the text to be processed or the event to which the text to be processed belongs (for example based on the tag attached to the text) or according to the credibility of the source (for example, journal articles take precedence over online articles) of the pieces of relevant knowledge, so as to leave the pieces of relevant knowledge having the quantity not greater than the preset processing limit.

As aforementioned, the relevant knowledge obtained by the knowledge text generator 12 according to the keywords may be from the unstructured knowledge database 21 and/or the structured knowledge database 22. In other words, the relevant knowledge may include unstructured knowledge and/or structured knowledge. For the relevant knowledge belonging to unstructured knowledge, its form is a textual description, so the knowledge text generator 12 may directly generate the target knowledge text using the relevant knowledge. For the relevant knowledge belonging to structured knowledge, before generating the target knowledge text, the knowledge text generator 12 may first convert the form of the relevant knowledge into a textual description according to another preset template (second preset template).

Taking the unstructured knowledge in the form of a triple of “entity(A)-relation(B)-entity(C)” as an example, the second preset template may be set to “the B of A is C”, but not limited to this.

The following are three examples of taking the question text as the text to be processed. They are the example where all the pieces of relevant knowledge belong to unstructured knowledge, the example where all the pieces of relevant knowledge belong to structured knowledge, and the example where the relevant knowledge has both unstructured knowledge and structured knowledge. These examples are merely illustrative and not intended to limit this disclosure.

In the first example, the question text is “What rights does the plaintiff want to defend?” The knowledge text generator 12 gets the textual description of the keyword “plaintiff” and the textual description of the keyword “rights” for the knowledge set, and the knowledge text generator 12 may generate the first knowledge text “(the textual description of plaintiff). (the textual description of rights)”. In the second example, the question text is “Can I take a bath during confinement?” The knowledge text generator 12 gets the triple “confinement-concept-postpartum care” of the keyword “confinement” and the triple “bath-effect-to remove dirt” of the keyword “bath” from the knowledge set, and the knowledge text generator 12 may convert the two triples into textual descriptions “the concept of confinement is postpartum care” and “the effect of a bath is to remove dirt”, and then concatenate the two textual descriptions in the order of the keywords in the question text so as to generate the target knowledge text. In the third example, the question text is “What is the date of birth of the legitimate child?” The knowledge text generator 12 gets the textual description of the keyword “legitimate child” and the triple of the keyword “date” from the knowledge set, and the knowledge text generator 12 first converts the triple of the keyword “date” into a textual description and then concatenate the textual descriptions in the order of the keywords in the question text. The above examples are merely illustrative and not intended to limit this disclosure.

As aforementioned, the machine reading comprehension system 1 may convert structured knowledge into a textual description by the knowledge text generator 12 so as to integrate unstructured knowledge and structured knowledge. The above-mentioned conversion and the subsequent operation of generating an answer by analyzing the article may have a lower operational complexity in comparison with the operation of generating an answer by directly analyzing structured knowledge.

In the following, steps S3 and S4 in FIG. 2 are described. It should be noted that FIG. 2 exemplarily shows that step S4 is performed after step S3, but in other embodiments, step S4 may be performed before step S3, or performed simultaneously with step S3. In steps S3 and S4, the semantic encoder 13 can encode the question text and the article text to generate an original target text code, and encode the first knowledge text and the second knowledge text to generate a knowledge text code. In other words, in step S3, the semantic encoder 13 takes the combination of the question text and the article text as the execution object of an encoding operation, and in step S4, the semantic encoder 13 takes the combination of the first knowledge text and the second knowledge text as the execution object of the encoding operation, wherein the so-called combination may be formed by directly concatenating the two pieces of text, or by first concatenating the two pieces of text and then adding separators at the beginning and end of the text concatenation and between the two pieces of text (e.g. adding [CLS] at the beginning, and adding [SEP] at the end and between the two pieces of text), but not limited to these.

The semantic encoder 13 can perform the encoding operation by a non-contextualized encoding method or a contextualized encoding method to generate the original target text code or the knowledge text code. In particular, the method of generating the original target text code and the method of generating the knowledge text code may be the same or different. The non-contextualized encoding method may include: splitting the execution object into tokens, obtaining initial vectors respectively corresponding to the tokens, and combining the initial vectors to generate the original target text code or the knowledge text code. In an example where the execution object is in English, the semantic encoder 13 may split the execution object into words directly according to the spaces in the execution object, or split the execution object into subwords by WordPiece algorithm, for example, split “playing” into “play” and “##ing”; in another example where the execution object is in Chinese, the semantic encoder 13 may split the execution object into characters, or split the execution object into words by a natural language analysis technique. The above examples are merely illustrative and not intended to limit this disclosure.

Each of the initial vectors may be merely a token embedding or include a token embedding, a segment embedding and a position embedding in the same dimensional space. For example, the initial vector may be the sum of the token embedding, the segment embedding and the position embedding. The token embedding represents the representative vector in a vector space of the corresponding token, and the way to obtain the token embeddings may be implemented using Word2Vec model or GloVe model. The segment embedding indicates whether the corresponding token belongs to the first text or the second text in the execution object. In an example where the combination of the question text and the article text serves as the execution object, the first text is the question text of which the corresponding segment embedding is a vector with code number 0, and the second text is the article text of which the corresponding segment embedding is a vector with code number 1. The position embedding represents the position of the corresponding token in all the tokens. The original target text code and the knowledge text code may each be a vector matrix composed of the initial vectors.

The contextualized encoding method may include: splitting the execution object into tokens; obtaining initial vectors respectively corresponding to the tokens; performing contextualized encoding on the initial vectors to generate encoded vectors; and combining the encoded vectors to generate the original target text code or the knowledge text code. As aforementioned, each of the initial vectors may be merely a token embedding, or include a token embedding, a segment embedding and a position embedding in the same dimensional space (e.g. being the sum of the token embedding, the segment embedding and the position embedding). The meanings of the token embedding, the segment embedding and the position embedding are as mentioned above and not repeated here.

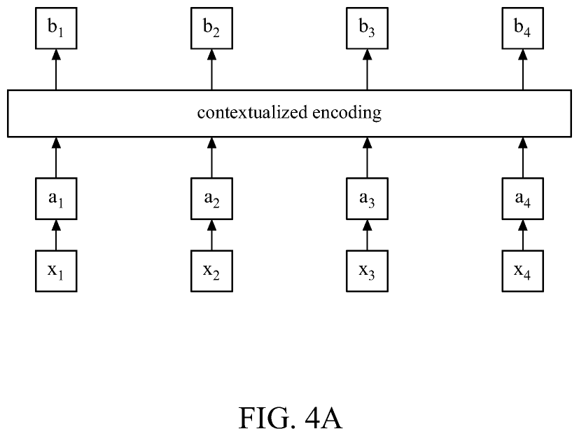

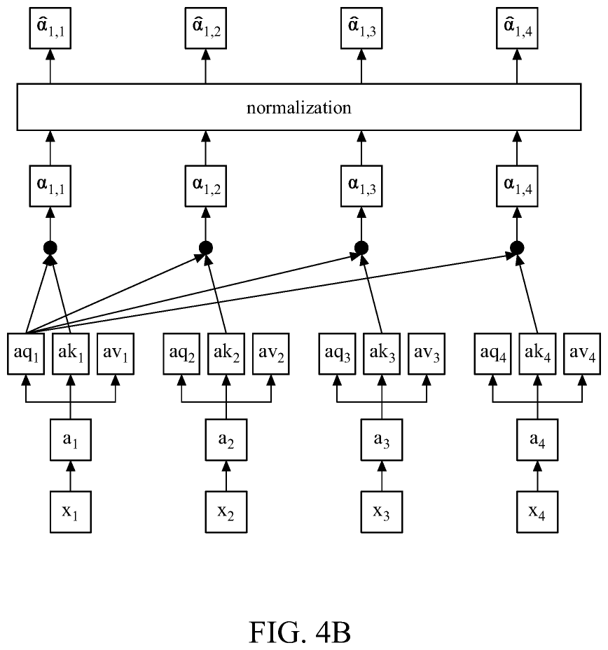

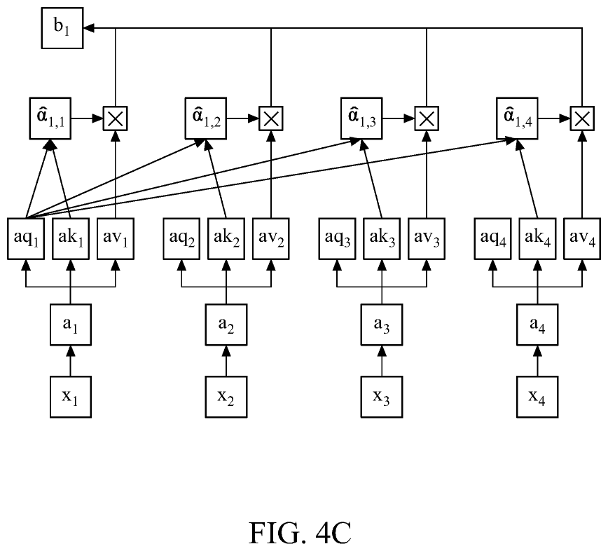

For a further description about an implementation of contextualized encoding, please refer to FIG. 1 and FIGS. 4A-4C, wherein FIGS. 4A-4C are schematic diagrams of an encoding task in a method for machine reading comprehension according to an embodiment of this disclosure. In FIG. 4A, the semantic encoder 13 splits the execution object into tokens x₁-x₄, and obtains initial vectors a₁-a₄ respectively corresponding to the tokens x₁-x₄ in the above-mentioned manner, and then, the semantic encoder 13 performs contextualized encoding on the initial vectors a₁-a₄ to generate encoded vectors b₁-b₄ respectively. The contextualized encoding performed on the initial vectors a₁-a₄ can be performed simultaneously or in a specific order. FIGS. 4B and 4C exemplarily illustrate the contextualized encoding operation performed on the initial vector a₁ for obtaining the encoded vector b₁. For the other initial vectors a₂-a₄, the same encoding operation is used for obtaining the encoded vectors b₂-b₄, so the details are not shown. Moreover, it should be noted that the number of tokens shown in FIGS. 4A-4C is merely an example, and this disclosure is not limited to this.

As shown in FIG. 4B, the semantic encoder 13 may generate a number of query vectors aq₁-aq₄, a number of key vectors ak₁-ak₄ and a number of value vectors av₁-av₄. More particularly, the mathematical formulas for the query vectors aq₁-aq₄, the key vectors ak₁-ak₄ and the value vectors av₁-av₄ may be expressed as the following mathematical formulas:

aqᵢ=W_{aq}aᵢ;

akᵢ=Wₐₖaᵢ;

avᵢ=Wₐᵥaᵢ.

wherein W_{ag}, Wₐₖ and Wₐᵥ are randomly given weight matrices, and the best weight matrices may be determined by analyzing the performance of the machine reading comprehension system 1 multiple times. The further optimization procedure is described later.

Then, the semantic encoder 13 may calculate dot products of the query vector aq₁ and each of the key vectors ak₁-ak₄ to obtain a number of initial weights α_{1,1}-α_{1,4}. Or, after calculating dot products, the semantic encoder 13 may further divide the calculation results of the dot products by the dimension of the query vector aq₁ and the key vectors ak₁-ak₄ to obtain the initial weights α_{1,1}-α_{1,4}, which may be expressed as the following mathematical formula:

α_{1,i}=aq₁·akᵢ/\sqrt{d},

wherein d represents the dimension of the query vector aq₁ and the key vectors ak₁-ak₄.

The semantic encoder 13 further performs normalization on the initial weights α_{1,1}-α_{1,4} to obtain a number of normalized weights \hat{α}_{1,1}-\hat{α}_{1,4}, wherein the normalization may be performed using Softmax function. The normalized weights \hat{α}_{1,1}-\hat{α}_{1,4} obtained by the calculation of Softmax function may be expressed in the following, but the normalization in this disclosure is not limited to the following and may be performed using other functions that make the sum of the weights be 1:

\hat{α}_{1,i}=exp(α_{1,i})/Σⱼ exp(α_{1,j}).

Then, as shown in FIG. 4C, the semantic encoder 13 performs weighted summation on the normalized weights \hat{α}_{1,1}-\hat{α}_{1,4} and the value vectors av₁-av₄ to obtain a weighted sum vector which serves as the encoded vector b₁ and may be expressed as the following mathematical formula:

$${b}_{1} = {\sum }_{i} {\hat{α}}_{1 , i} {av}_{i} .$$

The encoded vectors b₂-b₄ may be generated by the semantic encoder 13 using the above encoding operation. In another embodiment, the above encoding operation involving the query vectors aqᵢ-aq₄, the key vectors ak₁-ak₄ and the value vectors av₁-av₄ may be performed multiple times. In other words, the block of contextualized encoding in FIG. 4A may contain multiple layers. The semantic encoder 13 takes the initial vectors a₁-a₄ as the inputs of the first layer, takes the outputs of the first layer (i.e. the weighted sum vectors) as the inputs to the next layer, and so on. The outputs of the last layer serve as the encoded vectors b₁-b₄. The weight matrix used to generate query vectors, key vectors and value vectors in each layer is different. Therefore, the understanding level of the execution object of the machine reading comprehension system 1 may be increased. When the execution object of the encoding operation is the combination of the question text and the article text, the matrix composed of the encoded vectors b₁-b₄ is the original target text code, and when the execution object of the combination of the first knowledge text and the second knowledge text, the matrix composed of the encoded vectors b₁-b₄ is the knowledge text code.

In addition to the contextualized encoding as shown in FIGS. 4A-4C, the semantic encoder 13 may perform encoding methods of other kinds of contextualized encoders, such as BERT, RoBERTa, XLNet, ALBERT, ELMo using a long short-term memory (LSTM) based model, etc.

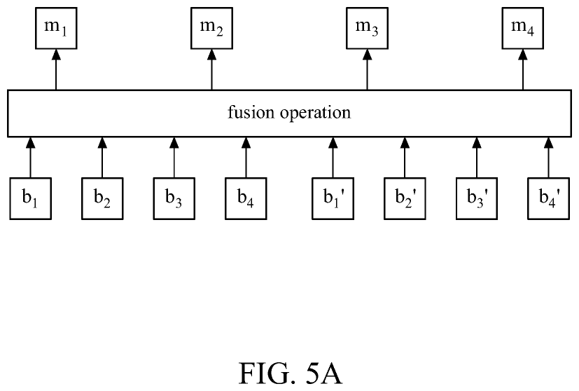

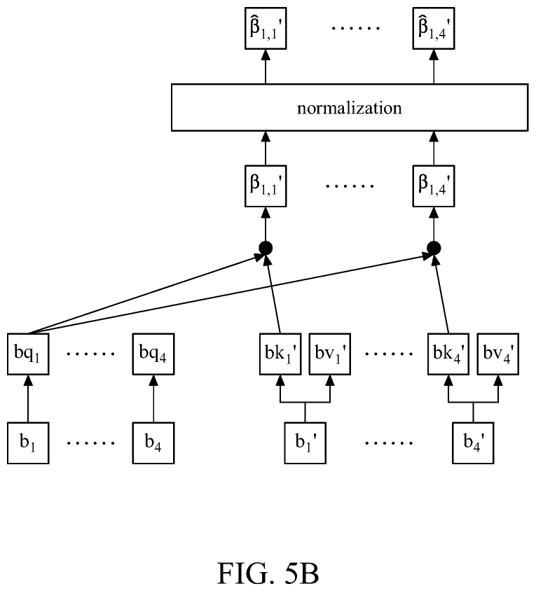

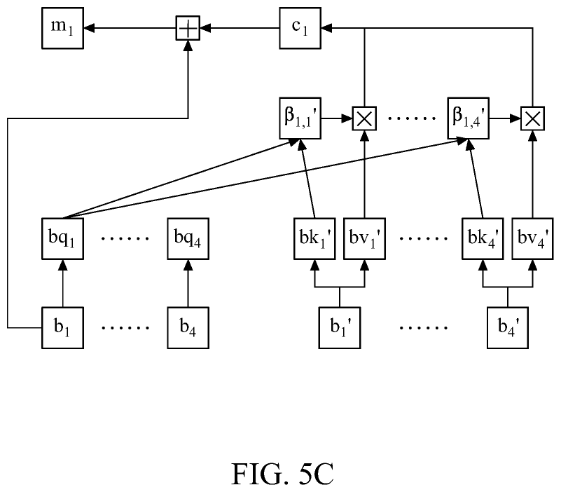

After the semantic encoder 13 performs the encoding task to generate the original target text code and the knowledge text code as mentioned above, the code fusion device 14 can perform a fusion operation on the original target text code and the knowledge text code to introduce part of knowledge in the knowledge set into the original target text code to generate a strengthened target text code, as step SS5 shown in FIG. 2. More particularly, please refer to FIG. 1 and FIGS. 5A-5C, wherein FIGS. 5A-5C are schematic diagrams of a fusion operation in a method for machine reading comprehension according to an embodiment of this disclosure. In FIG. 5A, the encoded vectors b₁-b₄ represent the encoded vectors contained in the original target text code, the encoded vectors b₁′-b₄′ represent the encoded vectors contained in the knowledge text code. The code fusion device 14 may perform the fusion operations on the encoded vectors b₁-b₄ in the original target text code and the encoded vectors b₁′-b₄′ in the knowledge text code to generate fused vectors m₁-m₄. The fusion operations for generating the fused vectors m₁-m₄ can be performed simultaneously or in a specific order. FIGS. 5B and 5C exemplarily illustrate the fusion operation performed on the encoded vector b₁ and the encoded vectors b₁′-b₄′ for obtaining the fused vector m₁. The same fusion operation may be performed on each of the other encoded vectors b₂-b₄ and the encoded vectors b₁′-b₄′ for obtaining the fused vectors m₂-m₄, so the details are not shown. Moreover, it should be noted that the number of encoded vectors shown in FIGS. 5A-5C is merely an example, and the number of the encoded vectors contained in the original target text code and the number of the encoded vectors contained in the knowledge text code do not actually need to be the same.

As shown in FIG. 5B, the code fusion device 14 may generate a number of query vectors bq₁-bq₄ according to the encoded vectors b₁-b₄ of the original target text code, and generate a number of key vectors bk₁′-bk₄′ and a number of value vectors bv₁′-bv₄′ according to the encoded vectors b₁′-b₄′ of the knowledge text code. More particularly, the mathematical formulas for the query vectors bq₁-bq₄, the key vectors bk₁′-bk₄′ and the value vectors bv₁′-bv₄′ may be expressed as the following mathematical formulas:

bqᵢ=W_{bq}bᵢ;

bkᵢ′=W_{bk}bᵢ′;

bvᵢ′=W_{bv}bᵢ′,

wherein W_{bq}, W_{bk} and W_{bv} are randomly given weight matrices, and the best weight matrices may be determined by analyzing the performance of the machine reading comprehension system 1 multiple times. The further optimization procedure is described later.

Then, the code fusion device 14 may calculate dot products of the query vector bq₁ and each of the key vectors bk₁′-bk₄′ to obtain a number of initial weights β_{1,1′}-β_{1,4′}. Or, after calculating dot products, the code fusion device 14 may further divide the calculation results of the dot products by the dimension of the query vector bq₁ and the key vectors bk₁′-bk₄′ to obtain the initial weights β_{1,1′}-β_{1,4′}, which may be expressed as the following mathematical formula:

β_{1,1′}=bq₁·bkᵢ′/\sqrt{d},

wherein d represents the dimension of the query vector bq₁ and the key vectors bk₁′-bk₄′. The above calculation can be regarded as determining the similarity between the encoded vector b₁ in the original target text code and each of the encoded vectors b₁′-b₄′ in the knowledge text code. In particular, the code fusion device 14 may use other functions used for determining similarity to implement the step of determining the similarity between the original target text code and the knowledge text code.

The code fusion device 14 further performs normalization on the initial weights β_{1,1′}-β_{1,4} to obtain a number of normalized weights \hat{β}_{1,1′}-\hat{β}_{1,4′}, wherein the normalization may be performed using Softmax function. The normalized weights normalized weights \hat{β}_{1,1′}-\hat{β}_{1,4′} obtained by the calculation of Softmax function may be expressed in the following, but the normalization in this disclosure is not limited to the following and may be performed using other functions that make the sum of the weights be 1:

\hat{β}_{1,i}=exp(β_{1,i})/Σⱼ exp(β_{1,j}).

Then, as shown in FIG. 5C, the code fusion device 14 performs weighted summation on the normalized weights \hat{β}_{1,1′}-\hat{β}_{1,4′} and the value vectors bv_{1′}-bv₄′ to obtain a weighted sum vector cᵢ, which may be expressed as the following mathematical formula:

$${c}_{1} = {\sum }_{i} {\hat{β}}_{1 , i} {bv}_{i}^{′}$$

The code fusion device 14 may add the weighted sum vector c₁ and the corresponding encoded vector b₁, and take the addition result as the fused vector m₁. Or, the code fusion device 14 may concatenate the weighted sum vector c₁ and the corresponding encoded vector b₁, and take the concatenation result as the fused vector m₁ with twice dimension (if each of the weighted sum vector c₁ and the encoded vector b₁ is a d-dimensional vector, the fused vector m₁ generated by concatenating the two is a 2d-dimensional vector). The fused vectors m₂-m₄ may be generated by the code fusion device 14 using the above fusion operation. The code fusion device 14 may combine the fused vectors m₁-m₄ to form a matrix, and use this matrix as the strengthened target text code.

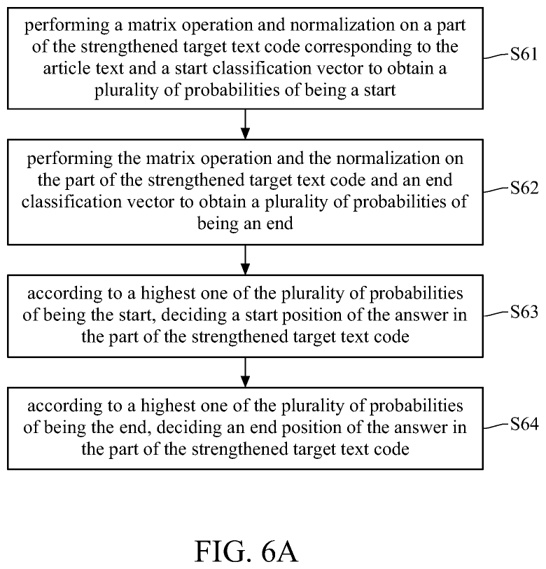

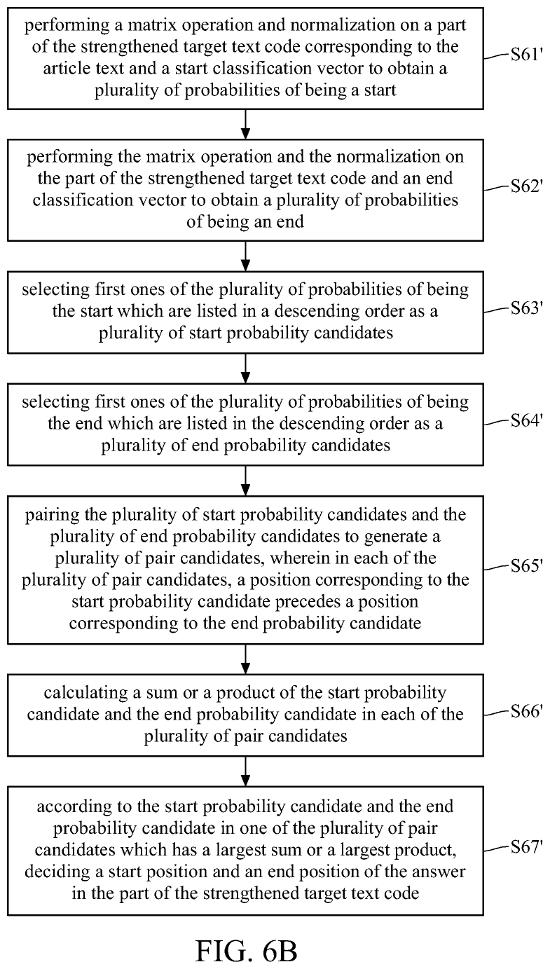

After the code fusion device 14 performs the fusion operation as mentioned above so as to introduce knowledge into the original target text code to generate the strengthened target text code, the answer extractor 15 can then obtain the answer corresponding to the question text based on the strengthened target text code, and output the answer through the input-output interface 11 (i.e. steps S6 and S7 in FIG. 2). More particularly, the answer extractor 15 may extract the answer corresponding to the question text from the strengthened target text code. Please refer to FIG. 1, FIG. 6A and FIG. 6B, wherein FIGS. 6A and 6B are flow charts of an answer extraction task in a method for machine reading comprehension according to two embodiments of this disclosure respectively.

As shown in FIG. 6A, the answer extraction task performed by the answer extractor 15 may include step S61: performing a matrix operation and normalization on a part of the strengthened target text code corresponding to the article text and a start classification vector to obtain a plurality of probabilities of being a start; step S62: performing the matrix operation and the normalization on the part of the strengthened target text code and an end classification vector to obtain a plurality of probabilities of being an end; step S63: according to a highest one of the plurality of probabilities of being the start, deciding a start position of the answer in the part of the strengthened target text code; and step S64: according to a highest one of the plurality of probabilities of being the end, deciding an end position of the answer in the part of the strengthened target text code.

In steps S61 and S62, the answer extractor 15 performs a matrix operation (particularly a dot product) and normalization on a part of the strengthened target text code corresponding to the article text and a start classification vector, and on the part of the strengthened target text code and an end classification vector, so as to obtain probabilities of being the start and probabilities of being the end. Particularly, the part of the strengthen target text code is a vector matrix composed of part of the fused vectors obtained by the code fusion device 14, wherein said part of the fused vectors correspond to the initial vectors belonging to the article text. More particularly, the question text and article text corresponding to the fused vectors may have indicators (e.g. 0/1 mask) when being input to the system in order to show whether their positions belong to an article or a question. The operation of step S61 may be expressed as the following formula:

$${P}_{i}^{s} = \frac{{e}^{S \cdot {T}_{i}}}{{Σ}_{j} {e}^{S \cdot {T}_{j}}} ,$$

wherein Pᵢ^{S} represents the i^{th} probability of being the start in a start probability vector, with the start probability vector including a number of probabilities of being the start each of which indicates the probability that the corresponding fused vector in the part of the strengthened target text code is the start position of the answer, S represents the start classification vector, and Tᵢ presents the i^{th} fused vector in the part of the strengthened target text code Similarly, step S62 may be expressed by the above mathematical formula where Pᵢ^{S} is replaced by Pᵢ^{E} to represent the i^{th} probability of being the end in an end probability vector, with the end probability vector including a number of probabilities of being the end each of which indicates the probability that the corresponding fused vector in the part of the strengthened target text code is the end position of the answer, and S is replaced by E to represents the end classification vector. The start classification vector and the end classification vector are randomly given vectors, and the best vectors may be determined by analyzing the performance of the machine reading comprehension system 1 multiple times. The further optimization procedure is described later.

In steps S63 and S64, the answer extractor 15 may decide that the fused vector corresponding to the highest one of the probabilities of being the start is the start position (i.e. start index) of the answer, and decide that the fused vector corresponding to the highest one of the probabilities of being the end is the end position (i.e. end index) of the answer. For example, if the probabilities of being the start in the start probability vector are 0.02, 0.90, 0.05, 0.01 and 0.02 in sequence, the answer extractor 15 decides that the start position of the answer corresponds to the second fused vector in the part of the target strengthened target text code corresponding to the article text. The end position of the answer is decided in the same way as the start position, so no other examples are given here.

It should be noted that step S63 is performed after step S61 and step S64 is performed after step S62, but the order of performing steps S61 and S62, the order of performing steps S61 and S64, the order of performing steps S62 and S63 and the order of performing steps S63 and S64 are not limited in this disclosure.

The answer extractor 15 may perform another implementation of the answer extraction task. As shown in FIG. 6B, the answer extraction task may include step S61′: performing a matrix operation and normalization on a part of the strengthened target text code corresponding to the article text and a start classification vector to obtain a plurality of probabilities of being a start; step S62′: performing the matrix operation and the normalization on the part of the strengthened target text code and an end classification vector to obtain a plurality of probabilities of being an end; step S63′: selecting first ones of the plurality of probabilities of being the start which are listed in a descending order as a plurality of start probability candidates; step S64′: selecting first ones of the plurality of probabilities of being the end which are listed in the descending order as a plurality of end probability candidates; step S65′: pairing the plurality of start probability candidates and the plurality of end probability candidates to generate a plurality of pair candidates, wherein in each of the plurality of pair candidates, a position corresponding to the start probability candidate precedes a position corresponding to the end probability candidate; step S66′: calculating a sum or a product of the start probability candidate and the end probability candidate in each of the plurality of pair candidates; step S67′: according to the start probability candidate and the end probability candidate in one of the plurality of pair candidates which has a largest sum or a largest product, deciding a start position and an end position of the answer in the part of the strengthened target text code.

The further implementation of steps S61′ and S62′ is the same as that of steps S61 and S62 in FIG. 6A, and not repeated here. In steps S63′ and S64′, the answer extractor 15 selects top probabilities of being the start as start probability candidates and selects top probabilities of being the end as end probability candidates. For example, the number of the selected start/end probability candidates is 5, but not limited to this. In step S65′, for each of the start probability candidates, the answer extractor 15 may pair it with each of the end probability candidates, and filter out the pair(s) in which the position corresponding to the start probability candidate is located after the position corresponding to the end probability candidate, so as to generate a number of pair candidates. In other words, in each of the pair candidates, the position corresponding to the start probability candidate precedes the position corresponding to the end probability candidate. In steps S66′ and S67′, the answer extractor 15 calculates the sum or product of the start probability candidate and the end probability candidate in each of the pair candidates, and decides that the fused vector corresponding to the start probability candidate in the pair candidate having the largest sum or the largest product is the start position of the answer, and the fused vector corresponding to the end probability candidate in the same pair candidate is the end position of the answer.

With the implementation of the answer extraction task as shown in FIG. 6B, the answer extractor 15 may avoid the situation where the start position is larger than the end position (i.e. the start position is after the end position), and accordingly, the accuracy of answer prediction may be improved. It should be noted that step S63′ is performed after step S61′ and step S64′ is performed after step S62′, but the order of performing steps S61′ and S62′, the order of performing steps S61′ and S64′, the order of performing steps S62′ and S63′ and the order of performing steps S63′ and S64′ are not limited in this disclosure.

Moreover, as aforementioned, the operating parameters (e.g. weight matrices W_{aq}, Wₐₖ and Wₐᵥ) of the encoding task performed by the semantic encoder 13, the operating parameters (e.g. weight matrices W_{bq}, W_{bk} and W_{bv}) of the fusion operation performed by the code fusion device 14 and the operating parameters (start classification vector and the end classification vector) of the answer extraction task performed by the answer extractor 15 may be optimized by the optimization process. In particular, steps S2-S6 of the method for machine reading comprehension shown in FIG. 2 may be an answer prediction process performed by the machine reading comprehension system 1 which has been trained by a training process, or be a part of the training process of the machine reading comprehension system 1, wherein the training process includes the procedure for optimizing the operating parameters.

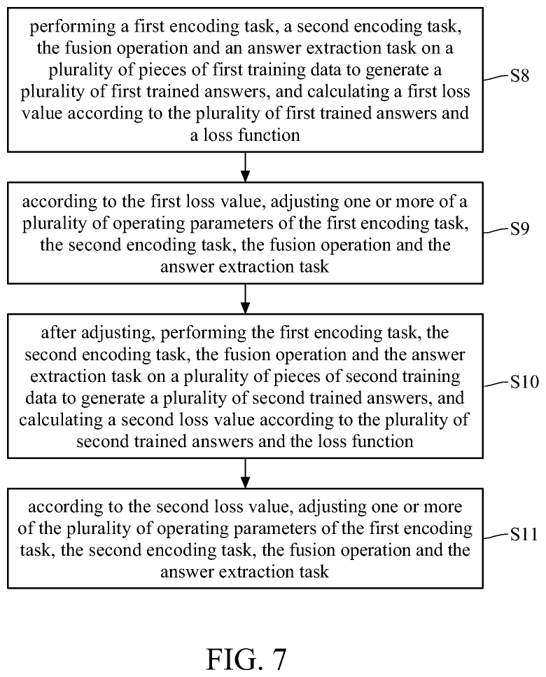

Please refer to FIG. 1, FIG. 2 and FIG. 7, wherein FIG. 7 is a flow chart of optimization of operating parameters in a method for machine reading comprehension according to an embodiment of this disclosure. As shown in FIG. 7, a procedure for optimizing the operating parameters may include step S8: performing a first encoding task, a second encoding task, the fusion operation and an answer extraction task on a plurality of pieces of first training data to generate a plurality of first trained answers, and calculating a first loss value according to the plurality of first trained answers and a loss function; step S9: according to the first loss value, adjusting one or more of a plurality of operating parameters of the first encoding task, the second encoding task, the fusion operation and the answer extraction task; step S10: after adjusting, performing the first encoding task, the second encoding task, the fusion operation and the answer extraction task on a plurality of pieces of second training data to generate a plurality of second trained answers, and calculating a second loss value according to the plurality of second trained answers and the loss function; step S11: according to the second loss value, adjusting one or more of the plurality of operating parameters of the first encoding task, the second encoding task, the fusion operation and the answer extraction task. Each of the pieces of first/second training data includes question text and article text. The first encoding task includes the step of encoding the question text and the article text to generate the original target text code as described in the aforementioned embodiments. The second encoding task includes the steps of generating the first knowledge text and the second according to the knowledge set and encoding the first knowledge text and the second knowledge text to generate the knowledge text code as described in the aforementioned embodiments. In other words, step S8 in FIG. 7 may include performing steps S2-S6 in FIG. 2 on each of the pieces of first training data, and step S10 in FIG. 7 may include performing steps S2-S6 in FIG. 2 on each of the pieces of second training data.

Steps S8-S11 can be performed by a processing device set up outside or inside the machine reading comprehension system 1. The processing device includes a central processing unit (CPU), a microcontroller, a programmable logic controller (PLC) or other processor, and is connected to the semantic encoder 13, the code fusion device 14 and the answer extractor 15. The processing device controls the devices connected thereto to operate on pieces of first training data using the current operating parameters to generate first trained answers, generate a first loss value according to the first trained answers and a loss function, and adjust one or more of the operating parameters of the devices according to the first loss value. Then, the processing device further controls the devices to operate on pieces of second training data after the adjustment of the operating parameter(s) to generate second trained answers, generate a second loss value according to the second trained answers and the loss function, and then adjust one or more of the operating parameters according to the second loss value. The loss function used to calculate the first/second loss value may be expressed as the following mathematical formula:

$$loss value = \frac{1}{N} {\sum }_{T = 1}^{N} ( {y}_{T}^{S} log ( {P}_{T}^{S} ) + {y}_{T}^{E} log ( {P}_{T}^{E} ) )$$

wherein y_{T}^{S} is the vector representing the start position of the correct answer, P_{T}^{S} represents the start probability vector calculated by the answer extractor 15, y_{T}^{E} is the vector representing the end position of the correct answer, P_{T}^{E} represents the end probability vector calculated by the answer extractor 15, and N represents the quantity of the pieces of training data used for generating the trained answers.

After step S11, the processing device may perform step S10 on other pieces of training data to calculate another loss value, and perform step S11 again using this loss value. These steps may be repeatedly performed multiple times. In other words, the processing device may perform training multiple times, and the loss value calculated during the training may be used as the basis for adjusting the operating parameters before the next training More particularly, the processing device may use a batch size of training data (first training data) and the current operating parameters to determine answers (first trained answers), and calculate a loss value (first loss value) according to the answers; then, the processing device adjusts operating parameters according to this loss value, and uses another batch size of training data (second training data) and the adjusted operating parameters to determine answers (second trained answer) and calculate the corresponding loss value (second loss value); then, the processing device adjusts the operating parameters according to this loss value, and uses yet another batch size of training data and the adjusted operating parameters to determine answers and calculate the corresponding loss value, and so on. For example, if the total quantity of pieces of training data is 2560 and each batch size is 32, one epoch of training includes performing the adjustment of the operating parameters and the subsequent process of determining answers and calculating a loss value as above-mentioned 80 times. After one epoch of training, the processing device may further shuffle all the pieces of training data, and then perform the next epoch of training In particular, how many epochs of training need to be performed is the setting of hyperparameters, and may be decided based on the performance (e.g. loss value, EM or F1 score) of the validation set which is the remaining part of the data in the training dataset.

Theoretically, as the number of epochs of training increases, the operating parameters will more fit the training data. However, when the operating parameters overfit the training data, the prediction accuracy of the new data (the data to be predicted) may decrease. Therefore, as mentioned above, the processing device may remain part of the data in the training dataset as the validation set, perform prediction on the validation set to obtain the corresponding prediction performance, and accordingly decide the appropriate number of epochs of training For example, after one epoch of training, the processing device may determine whether the performance of the validation set in this epoch of training is better (e.g. having a lower loss value or higher EM/F1 score) than that in the previous epoch. If the performance of the validation set in this epoch is better than that in the previous epoch, the next epoch of training is continued; if it is worse or does not change much, the training is stopped. After the above-mentioned training process, the optimum operating parameters may be obtained.

The source of the question text and the article text used for training may be the target labeled dataset, that is, the dataset to be predicted by the system, and the source of the knowledge set used for generating the knowledge text is the knowledge database corresponding to the target labeled dataset (e.g. in the same type). In another embodiment, before using the target labeled dataset for training, the method for machine reading comprehension may be trained using an external labeled dataset and its corresponding knowledge database (e.g. in the same type); that is, the external labeled dataset is taken as the source of the question text and the article text, and the knowledge database corresponding to the external labeled dataset is taken as the source of the knowledge set, so as to decide the optimum operating parameters for the first time. In an example where the labeled datasets include DRCD, CMRC 2018 and CAIL 2019, when the target labeled dataset is DRCD, one or both of CMRC 2018 and CAIL 2019 may be used as the training dataset to first determine the optimum operating parameters, and then DRCD may be used as the training dataset to determine the optimum operating parameters again. By the above procedure for optimizing the operating parameters, unsatisfactory training results caused by incomplete labeling of the target labeled dataset may be avoided.

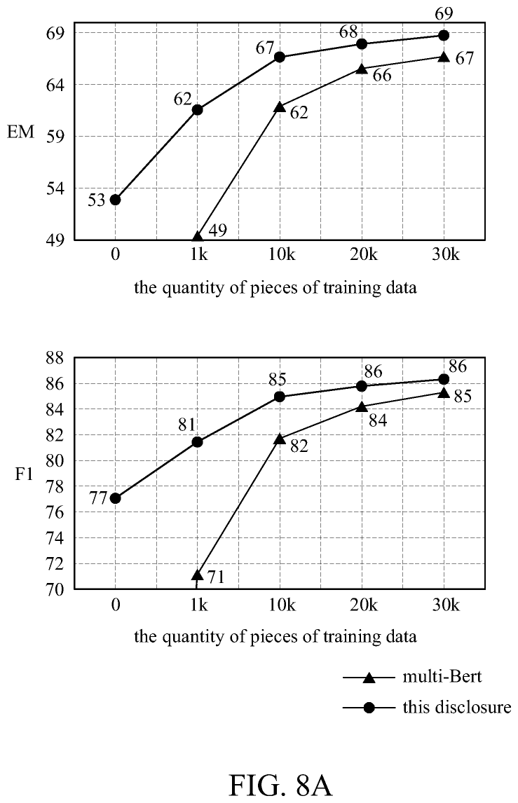

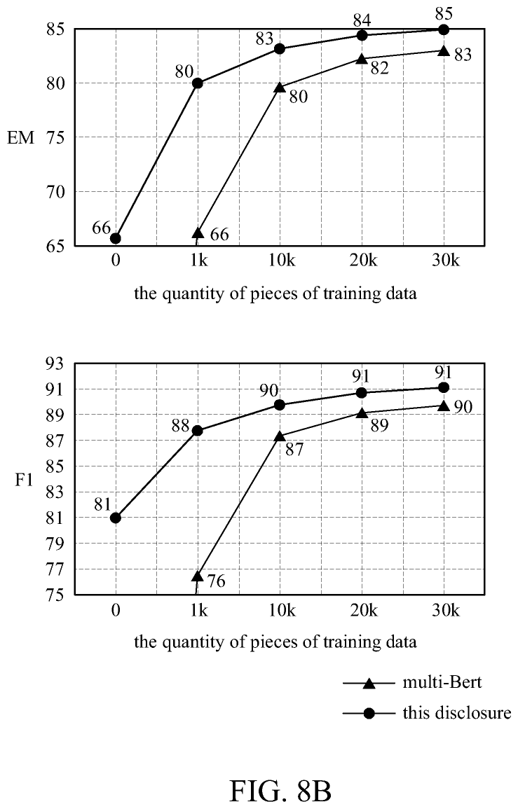

Please refer to FIGS. 8A and 8B, wherein FIGS. 8A and 8B are comparison charts of experimental data obtained using two kinds of training data by an existing method and system for machine reading comprehension (multi-Bert) and by the method and system for machine reading comprehension in an embodiment of this disclosure. In the experiment of FIG. 8A, the method and system for machine reading comprehension of this disclosure and the existing method and system for machine reading comprehension use the dataset CAIL 2019 in the legal field as the source of the training data, and the method and system for machine reading comprehension of this disclosure further use OpenBase (knowledge base of unstructured knowledge) and HowNet (knowledge base of structured knowledge) as the source of the knowledge set. In the experiment of FIG. 8B, the method and system for machine reading comprehension of this disclosure and the existing method and system for machine reading comprehension use the dataset DRCD involving various fields as the source of the training data, and the method and system for machine reading comprehension of this disclosure further use HowNet as the source of the knowledge set.

The experimental data EM (Exact Match) shown in FIGS. 8A and 8B represents the consistent ratio of the predicted answer to the standard answer (unit: %), and F1 is the score of accuracy calculated using the wordized predicted answer and the wordized standard answer. More particularly, F1 may be expressed as the following mathematical formula:

$$F 1 = 2 \cdot \frac{precision \cdot recall}{precision + recall} \times 100 ,$$

wherein precision indicates what percentage of the words in the predicted answer appear in the standard answer, and recall indicates what percentage of words in the standard answer appear in the predicted answer.

As shown in FIGS. 8A and 8B, the method and system for machine reading comprehension in this disclosure have higher EM and F1 than the existing method and system for machine reading comprehension; that is, the method and system for machine reading comprehension in this disclosure have higher accuracy of answer prediction. The method and system for machine reading comprehension in this disclosure have considerable performance when the amount of training data is small, which means that in the early stage of system training, it may assist the labeling personnel to speed data labeling up. Even with merely 1k pieces of training data, the value of EM may reach 80% of the level of human judgement, which means the possibility of replacing manual task and maintaining the same accuracy. Moreover, F1 score may also be close to human level (F1 score: 92).

With the above architecture, the method and system for machine reading comprehension in this disclosure may perform specific encoding and fusion operations to introduce external knowledge in the process of analyzing problems and articles, thereby avoiding the problem that it is difficult to obtain a correct answer from an article due to the simple content of the article, and improving the accuracy of answer prediction.

Although the aforementioned embodiments of this disclosure have been described above, this disclosure is not limited thereto. The amendment and the retouch, which do not depart from the spirit and scope of this disclosure, should fall within the scope of protection of this disclosure. For the scope of protection defined by this disclosure, please refer to the attached claims.

### SYMBOLIC EXPLANATION

1 system for machine reading comprehension

11 input-output interface

12 knowledge text generator

13 semantic encoder

14 code fusion device

15 answer extractor

21 unstructured knowledge database

22 structured knowledge database

x₁-x₄ token

a₁-a₄ initial vectors

b₁-b₄, b₁′-b₄′ encoded vector

aq₁-aq₄, bq₁-bq₄ query vector

ak₁-ak₄, bk₁′-bk₄′ key vectors

av₁-av₄, bv₁′-bv₄′ value vectors

α_{1,1}-α_{1,4}, β_{1,1′}-β_{1,4′} initial weights

\hat{α}_{1,1}-\hat{α}_{1,4}, \hat{β}_{1,1′}-\hat{β}_{1,4′} normalized weights

m₁-m₄ fused vector

c₁ weighted sum vector

S1-S7 step

S21-S25 step

S61-S62 step

S8-S11 step

What is claimed is:

1. A method for machine reading comprehension, comprising:
obtaining question text and article text associated with the question text;
generating first knowledge text corresponding to the question text and second knowledge text corresponding to the article text according to a knowledge set;
encoding the question text and the article text to generate an original target text code;
encoding the first knowledge text and the second knowledge text to generate a knowledge text code;
performing a fusion operation on the original target text code and the knowledge text code to introduce part of knowledge in the knowledge set into the original target text code to generate a strengthened target text code; and
obtaining an answer corresponding to the question text based on the strengthened target text code, and outputting the answer.

2. The method for machine reading comprehension according to claim 1, wherein generating the first knowledge text corresponding to the question text and the second knowledge text corresponding to the article text according to the knowledge set comprises:
taking each of the question text and the article text as text to be processed, performing:
splitting the text to be processed into a plurality of words;
searching the knowledge set for at least one piece of relevant knowledge according to the plurality of words;
when a quantity of the at least one piece of relevant knowledge is one, generating target knowledge text according to the piece of relevant knowledge; and
when the quantity of the at least one piece of relevant knowledge is more than one, combining the pieces of relevant knowledge according to an order of the plurality of words and a preset template to generate the target knowledge text;
wherein the target knowledge text corresponding to the question text is the first knowledge text, and the target knowledge text corresponding to the article text is the second knowledge text.

3. The method for machine reading comprehension according to claim 2, wherein generating the first knowledge text corresponding to the question text and the second knowledge text corresponding to the article text according to the knowledge set further comprises:
if the at least one piece of relevant knowledge belongs to structured knowledge, before generating the target knowledge text, converting a form of the at least one piece of relevant knowledge into a textual description according to another preset template.

4. The method for machine reading comprehension according to claim 1, wherein performing the fusion operation of the original target text code and the knowledge text code to introduce part of the knowledge in the knowledge set into the original target text code to generate the strengthened target text code comprises:
according to the original target text code, generating a plurality of query vectors;
according to the knowledge text code, generating a plurality of key vectors and a plurality of value vectors;
for each of the plurality of query vectors, performing:
calculating a dot product of each of the plurality of query vectors and a respective one of the plurality of key vectors to obtain a plurality of initial weights;
performing normalization on the plurality of initial weights respectively to obtain a plurality of normalized weights; and
performing weighted summation on the plurality of normalized weights and the plurality of value vectors to obtain a weighted sum vector; and
generating the strengthened target text code according to the weighted sum vector corresponding to each of the plurality of query vectors.

5. The method for machine reading comprehension according to claim 4, wherein the original target text code comprises a plurality of encoded vectors respectively corresponding to the plurality of query vectors, and generating the strengthened target text code according to the weighted sum vector corresponding to each of the plurality of query vectors comprises:
adding or concatenating the weighted sum vector and the encoded vector corresponding to each of the plurality of query vectors to obtain a plurality of fused vectors; and
combining the plurality of fused vectors to generate the strengthened target text code.

6. The method for machine reading comprehension according to claim 1, wherein encoding the question text and the article text comprises: taking a combination of the question text and the article text as an execution object of an encoding operation, encoding the first knowledge text and the second knowledge text comprises: taking a combination of the first knowledge text and the second knowledge text as the execution object of the encoding operation, and the encoding operation comprises:
splitting the execution object into a plurality of tokens;
obtaining a plurality of initial vectors respectively corresponding to the plurality of tokens; and
combining the plurality of initial vectors to generate the original target text code or the knowledge text code.

7. The method for machine reading comprehension according to claim 1, wherein encoding the question text and the article text comprises: taking a combination of the question text and the article text as an execution object of an encoding operation, encoding the first knowledge text and the second knowledge text comprises: taking a combination of the first knowledge text and the second knowledge text as the execution object of the encoding operation, and the encoding operation comprises:
splitting the execution object into a plurality of tokens;
obtaining a plurality of initial vectors respectively corresponding to the plurality of tokens;
according to the plurality of initial vectors, generating a plurality of query vectors, a plurality of key vectors and a plurality of value vectors;
for each of the plurality of query vectors, performing:
calculating a dot product of each of the plurality of query vectors and a respective one of the plurality of key vectors to obtain a plurality of initial weights;
performing normalization on the plurality of initial weights respectively to obtain a plurality of normalized weights; and
performing weighted summation on the plurality of normalized weights and the plurality of value vectors to obtain a weighted sum vector;
generating a plurality of encoded vectors according to the weighted sum vector corresponding to each of the plurality of query vectors; and
combining the plurality of encoded vectors to generate the original target text code or the knowledge text code.

8. The method for machine reading comprehension according to claim 1, wherein obtaining the answer corresponding to the question text based on the strengthened target text code comprises:
performing a matrix operation and normalization on a part of the strengthened target text code corresponding to the article text and a start classification vector to obtain a plurality of probabilities of being a start;
performing the matrix operation and the normalization on the part of the strengthened target text code and an end classification vector to obtain a plurality of probabilities of being an end;
according to a highest one of the plurality of probabilities of being the start, deciding a start position of the answer in the part of the strengthened target text code; and
according to a highest one of the plurality of probabilities of being the end, deciding an end position of the answer in the part of the strengthened target text code.

9. The method for machine reading comprehension according to claim 1, wherein obtaining the answer corresponding to the question text based on the strengthened target text code comprises:
performing a matrix operation and normalization on a part of the strengthened target text code corresponding to the article text and a start classification vector to obtain a plurality of probabilities of being a start;
performing the matrix operation and the normalization on the part of the strengthened target text code and an end classification vector to obtain a plurality of probabilities of being an end;
selecting first ones of the plurality of probabilities of being the start which are listed in a descending order as a plurality of start probability candidates;
selecting first ones of the plurality of probabilities of being the end which are listed in the descending order as a plurality of end probability candidates;
pairing the plurality of start probability candidates and the plurality of end probability candidates to generate a plurality of pair candidates, wherein in each of the plurality of pair candidates, a position corresponding to the start probability candidate precedes a position corresponding to the end probability candidate;
calculating a sum or a product of the start probability candidate and the end probability candidate in each of the plurality of pair candidates; and
according to the start probability candidate and the end probability candidate in one of the plurality of pair candidates which has a largest sum or a largest product, deciding a start position and an end position of the answer in the part of the strengthened target text code.

10. The method for machine reading comprehension according to claim 1, further comprising:
performing a first encoding task, a second encoding task, the fusion operation and an answer extraction task on a plurality of pieces of first training data to generate a plurality of first trained answers, and calculating a first loss value according to the plurality of first trained answers and a loss function;
according to the first loss value, adjusting one or more of a plurality of operating parameters of the first encoding task, the second encoding task, the fusion operation and the answer extraction task;
after adjusting, performing the first encoding task, the second encoding task, the fusion operation and the answer extraction task on a plurality of pieces of second training data to generate a plurality of second trained answers, and calculating a second loss value according to the plurality of second trained answers and the loss function; and
according to the second loss value, adjusting one or more of the plurality of operating parameters;
wherein the first encoding task comprises encoding the question text and the article text, the second encoding task comprises encoding the first knowledge text and the second knowledge text, and the answer extraction task comprises obtaining the answer corresponding to the question text.

11. A system for machine reading comprehension, comprising:
an input-output interface configured to obtain question text and article text associated with the question text;
a knowledge text generator connected to the input-output interface, and configured to obtain first knowledge text corresponding to the question text and second knowledge text corresponding to the article text according to a knowledge set;
a semantic encoder connected to the input-output interface and the knowledge text generator, and configured to encode the question text and the article text to generate an original target text cod and to encode the first knowledge text and the second knowledge text to generate a knowledge text code;
a code fusion device connected to the semantic encoder, and configured to perform a fusion operation on the original target text code and the knowledge text code to introduce part of knowledge in the knowledge set into the original target text code to generate a strengthened target text code;
an answer extractor connected to the code fusion device and the input-output interface, and configured to obtain an answer corresponding to the question text based on the strengthened target text code and to output the answer through the input-output interface.

12. The system for machine reading comprehension according to claim 11, wherein generating the first knowledge text corresponding to the question text and the second knowledge text corresponding to the article text according to the knowledge set performed by the knowledge text generator comprises:
taking each of the question text and the article text as text to be processed, performing:
splitting the text to be processed into a plurality of words;
searching the knowledge set for at least one piece of relevant knowledge according to the plurality of words;
when a quantity of the at least one piece of relevant knowledge is one, generating target knowledge text according to the piece of relevant knowledge; and
when the quantity of the at least one piece of relevant knowledge is more than one, combining the pieces of relevant knowledge according to an order of the plurality of words and a preset template to generate the target knowledge text;
wherein the target knowledge text corresponding to the question text is the first knowledge text, and the target knowledge text corresponding to the article text is the second knowledge text.

13. The system for machine reading comprehension according to claim 12, wherein generating the first knowledge text corresponding to the question text and the second knowledge text corresponding to the article text according to the knowledge set performed by the knowledge text generator further comprises:
if the at least one piece of relevant knowledge belongs to structured knowledge, before generating the target knowledge text, converting a form of the at least one piece of relevant knowledge into a textual description according to another preset template.

14. The system for machine reading comprehension according to claim 11, wherein performing the fusion operation of the original target text code and the knowledge text code to introduce part of the knowledge in the knowledge set into the original target text code to generate the strengthened target text code performed by the code fusion device comprises:
according to the original target text code, generating a plurality of query vectors;
according to the knowledge text code, generating a plurality of key vectors and a plurality of value vectors;
for each of the plurality of query vectors, performing:
calculating a dot product of each of the plurality of query vectors and a respective one of the plurality of key vectors to obtain a plurality of initial weights;
performing normalization on the plurality of initial weights respectively to obtain a plurality of normalized weights; and
performing weighted summation on the plurality of normalized weights and the plurality of value vectors to obtain a weighted sum vector; and
generating the strengthened target text code according to the weighted sum vector corresponding to each of the plurality of query vectors.

15. The system for machine reading comprehension according to claim 14, wherein the original target text code comprises a plurality of encoded vectors respectively corresponding to the plurality of query vectors, and generating the strengthened target text code according to the weighted sum vector corresponding to each of the plurality of query vectors performed by the code fusion device comprises:
adding or concatenating the weighted sum vector and the encoded vector corresponding to each of the plurality of query vectors to obtain a plurality of fused vectors; and
combining the plurality of fused vectors to generate the strengthened target text code.

16. The system for machine reading comprehension according to claim 11, wherein encoding the question text and the article text performed by the semantic encoder takes a combination of the question text and the article text as an execution object of an encoding operation, encoding the first knowledge text and the second knowledge text performed by the semantic encoder takes a combination of the first knowledge text and the second knowledge text as the execution object of the encoding operation, and the encoding operation comprises:
splitting the execution object into a plurality of tokens;
obtaining a plurality of initial vectors respectively corresponding to the plurality of tokens; and
combining the plurality of initial vectors to generate the original target text code or the knowledge text code.

17. The system for machine reading comprehension according to claim 11, wherein encoding the question text and the article text performed by the semantic encoder takes a combination of the question text and the article text as an execution object of an encoding operation, encoding the first knowledge text and the second knowledge text performed by the semantic encoder takes a combination of the first knowledge text and the second knowledge text as the execution object of the encoding operation, and the encoding operation comprises:
splitting the execution object into a plurality of tokens;
obtaining a plurality of initial vectors respectively corresponding to the plurality of tokens;
according to the plurality of initial vectors, generating a plurality of query vectors, a plurality of key vectors and a plurality of value vectors;
for each of the plurality of query vectors, performing:
calculating a dot product of each of the plurality of query vectors and a respective one of the plurality of key vectors to obtain a plurality of initial weights;
performing normalization on the plurality of initial weights respectively to obtain a plurality of normalized weights; and
performing weighted summation on the plurality of normalized weights and the plurality of value vectors to obtain a weighted sum vector;
generating a plurality of encoded vectors according to the weighted sum vector corresponding to each of the plurality of query vectors; and
combining the plurality of encoded vectors to generate the original target text code or the knowledge text code.

18. The system for machine reading comprehension according to claim 11, wherein obtaining the answer corresponding to the question text based on the strengthened target text code performed by the answer extractor comprises:
performing a matrix operation and normalization on a part of the strengthened target text code corresponding to the article text and a start classification vector to obtain a plurality of probabilities of being a start;
performing the matrix operation and the normalization on the part of the strengthened target text code and an end classification vector to obtain a plurality of probabilities of being an end;
according to a highest one of the plurality of probabilities of being the start, deciding a start position of the answer in the part of the strengthened target text code; and
according to a highest one of the plurality of probabilities of being the end, deciding an end position of the answer in the part of the strengthened target text code.

19. The system for machine reading comprehension according to claim 11, wherein obtaining the answer corresponding to the question text based on the strengthened target text code performed by the answer extractor comprises:
performing a matrix operation and normalization on a part of the strengthened target text code corresponding to the article text and a start classification vector to obtain a plurality of probabilities of being a start;
performing the matrix operation and the normalization on the part of the strengthened target text code and an end classification vector to obtain a plurality of probabilities of being an end;
selecting first ones of the plurality of probabilities of being the start which are listed in a descending order as a plurality of start probability candidates;
selecting first ones of the plurality of probabilities of being the end which are listed in the descending order as a plurality of end probability candidates;
pairing the plurality of start probability candidates and the plurality of end probability candidates to generate a plurality of pair candidates, wherein in each of the plurality of pair candidates, a position corresponding to the start probability candidate precedes a position corresponding to the end probability candidate;
calculating a sum or a product of the start probability candidate and the end probability candidate in each of the plurality of pair candidates; and
according to the start probability candidate and the end probability candidate in one of the plurality of pair candidates which has a largest sum or a largest product, deciding a start position and an end position of the answer in the part of the strengthened target text code.

20. The system for machine reading comprehension according to claim 11, further comprising a processing device, wherein the processing device is connected to the semantic encoder, the code fusion device and the answer extractor, and configured to control the semantic encoder, the code fusion device and the answer extractor to operate on a plurality of pieces of first training data to generate a plurality of first trained answers, to calculate a first loss value according to the plurality of first trained answers and a loss function, to adjust one or more of a plurality of operating parameters of the semantic encoder, the code fusion device and the answer extractor according to the first loss value, to control the semantic encoder, the code fusion device and the answer extractor to operate on a plurality of pieces of second training data to generate a plurality of second trained answers after adjusting, to calculate a second loss value according to the plurality of second trained answers and the loss function, and to adjust one or more of the plurality of operating parameters according to the second loss value.

21. The system for machine reading comprehension according to claim 11, wherein the input-output interface is further configured to output at least part of the knowledge set.
